(19) United States
(12) Patent Application Publication
(10) Pub. No.: US 2008/0000127 A1
(43) Pub. Date: Jan. 3, 2008

(54) MEMORABILIA KIT AND SYSTEM

(76) Inventor: Gary W. Shimer, Cummings, GA (US)

Correspondence Address: GEORGE R. REARDON, 3356 STATION COURT, LAWRENCVILLE, GA, 30044, US

(21) Appl. No.: 11/854,949

(22) Filed: Sep. 13, 2007

Related U.S. Application Data
(63) Continuation-in-part of application No. 11/280,781, filed on Nov. 16, 2005, now abandoned.

(51) Int. Cl. A47G 1/06; B44B 11/00

(52) U.S. Cl. 40/768; 30/164.9; 40/798

(57) ABSTRACT

A memorabilia kit and system directed to a more durable guest signature platform is disclosed. Elements include a memorabilia assembly, a signature engraving scribe, a polishing cloth and an instruction card. The memorabilia assembly is typically comprised of a frame, a metal signature mat board, a first backing material, a protective material, a second backing material, flex-tabs and hanging hardware. Additional elements of the memorabilia assembly may include a stock photo or document. Additional elements of the memorabilia kit may include an instruction card picture frame, an instruction card stand, a memorabilia assembly stand.

This application is a continuation in part of application Ser. No. 11/280,781, filed on Nov. 16, 2005, which is incorporated herein in its entirety.

### FIELD OF THE INVENTION

The technology described herein pertains generally to kits and systems for remembrances and memorabilia, and more particularly to a memorabilia kit directed to a more durable guest signature platform.

### BACKGROUND OF THE INVENTION

The memorabilia industry is a multimillion dollar annual industry. Special occasions traditionally have been memorialized with photographs, guest books, and the like. Weddings, birthdays, anniversaries, retirements, religious occasions, sports events, holiday events, military events, teacher appreciation, secretary's day, and other events that create memories are opportunities for creating a record of those in attendance.

In the past, this record took the form of an ink pen signed cardboard matted event photograph, a guest book, and the like. Signatures written in ink on a cardboard-matted photograph or a guest book have a tendency to fade over time. What is needed is a way to have a memorabilia device with a more lasting signature.

Related art that is directed to memorabilia and/or autograph devices includes the following patents and published patent applications.

U.S. Pat. No. 4,434,567 issued to LeVeau on Mar. 6, 1984, discloses a repository for memorabilia which affords visual and auditory sensations.

U.S. Pat. No. 5,277,949 issued to Green on Jan. 11, 1994, discloses a frame for athletic miniatures and sports memorabilia having a double-sided frame made of wooden material with glass members on both sides, and a stiffening board for supporting an athletic miniature or sports memorabilia assembled between the glass members, so that the athletic miniature or sports memorabilia can be viewed through the glass members from both sides of the frame.

U.S. Pat. No. 5,603,410 issued to Kara on Feb. 18, 1997, discloses a display box arranged to open from the top and includes a transparent lid connected to a bottom with an interior lining. Products to be displayed are then positioned inside the bottom of the box. A mat with cutouts of various shapes and sizes, each customized to reveal only a selected portion of a positioned memorabilia, is then placed on top of these memorabilia as the lid is closed thereby allowing the memorabilia to be viewed through the transparent lid.

U.S. Pat. No. 5,634,667 issued to Jordan on Jun. 3, 1997, discloses a book like album having a front cover with a hologram, photograph, painting or drawing placed thereon which will have a special meaning to the person who owns it. When opened one side of the inside of the album has a specific portion for poetry, memoir cards, a fragrance pouch, a pocket for the memoir cards and a section to display the union of fingerprints superimposed one over another in a specific shape made possible by stencil superimposition. The other portion of the inside has a section for holding art works, a picture, painting or a hologram. Also included inside the album are “Forever Treasure” removable cards about the size of credit cards, personalized with poetry. The album also has a pocket to secure these cards.

U.S. Pat. No. 6,170,185 issued to Donofrio, Jr. on Jan. 9, 2001, discloses a display device including a plaque, a hanger secured to a rear face of the plaque for hanging the plaque on a vertical surface such that the rear face of the plaque is substantially parallel with the vertical surface, a support assembly secured to a front face of the plaque, and memorabilia held by the support assembly, wherein the support is adapted to hold the memorabilia in an upright position with respect to the vertical surface.

U.S. Pat. No. 6,546,651 issued to Tremonti on Apr. 15, 2003, discloses a keepsake/ticket display and memorabilia device comprising a main card having a display window and a display card member pivotably connected to the main card. The display card member provides a flat surface upon which a ticket, ticket stub, or other generally flat keepsake can be mounted. The display card member is pivotable with respect to the main card such that it can be generally positioned under the display window of the main card, thereby displaying the ticket through the display window. Various indicia relating to a specific event for which the ticket was purchased can be printed on the main card thereby enhancing the display of the ticket.

U.S. Pat. No. 6,751,875 issued to Jones on Jun. 22, 2004, discloses a high-speed, hand-held attachment for flex rotor shafts of power rotary tools, and also for direct attachment to power rotary tools without flex rotor shafts, that converts rotary motion to reciprocating motion for precision control of cutting, carving, sawing, chiseling, filing, sanding, and engraving on delicate work pieces. The attachment is one assembly comprising a one-piece front one-piece enclosure, a rear one-piece enclosure, a high-speed bearing, a one-piece rotating piece with integral cam groove, a one-piece reciprocating piece with an integral cam follower on one end and with its other, exposed end accommodating the attachment of a chuck or collet and with geometry to prevent rotation, and a thumbscrew. Rotating piece attaches directly to the rotary power source and provides the cam action drive to reciprocating piece. Bearing provides rotative support for the other end of rotating piece. Reciprocating piece slidably mounts in front one-piece enclosure. Front one-piece enclosure and rear one-piece enclosure are attached to each other and maintain proper alignment for rotating piece, bearing, and reciprocating piece. Thumbscrew secures the attachment to the flex rotor shaft of a power rotary tool. A tool holder/collet is attached to the exposed end of reciprocating piece whereby numerous types of cutting tools may be utilized.

U.S. Pat. No. 6,845,585 issued to Callander et al. on Jan. 25, 2005, discloses an assembly for displaying an item of memorabilia in three-dimensions including: a rigid support substrate for mounting on a wall; a protective layer adapted to co-extensively abut a part of a surface of the rigid support, said protective layer including an opening therein; a memorabilia display housing, said housing including a shaped portion to receive a three-dimensional shaped item of memorabilia of similar size to the shaped portion, said shaped portion having at least a transparent or translucent viewing part; and in an assembled condition a part of the housing is held by the protective layer or the rigid support and an item of memorabilia is received within the shaped portion of the housing so as to enable display in a three-dimensional form.

U.S. Pat. No. 6,920,709 issued to LaMalfa on Jul. 26, 2005, discloses an article of sports memorabilia having collectable attractiveness attributes wherein common and personalized attributes are displayed on an article such as a home plate, tee shirt, glass or picture. The common attributes indicate the name of a stadium or field, a team, and a team player striking or kicking a sport ball such as a baseball, football or soccer ball. The personalized attributes indicate the name and address of a person or entity for whom the article is personalized, and the number of feet between the stadium or field, or home plate or other location on the field, and the address of the person for whom the article is personalized. A logo “From Our Home To Yours” on the article indicates the personalized distance between the field or stadium and the personalized address.

U.S. Pat. No. 6,973,747 issued to Ratmansky et al. on Dec. 13, 2005, discloses an item of sports memorabilia. Indicia are imprinted on a medallion using convention minting technology. An ice hockey puck has a cavity adapted to receive and to support the medallion for display. The cavity of the puck exerts a pre-selected force upon the medallion over a pre-selected area, holding the medallion in place during handling while allowing a collector to release the medallion from the puck. Alternatively, resilient or spring retaining members releasably engage the puck and the medallion.

U.S. Pat. No. D522,055 issued to Crippen on May 30, 2006 illustrates a golf memorabilia album.

U.S. Pat. No. 5,356,136 issued to Ippolito on Oct. 18, 1994 discloses a simplified autograph combination device to be used by autograph seekers, combining a flexible pen with an autographable vehicle where the vehicle may be defined as mainly a baseball or it could be a football or basketball etc. where the pen forms the same contour as the vehicle to be autographed and is attached to the vehicle with a removably-attached felt fastener.

U.S. Pat. No. D431,374 issued to Glover on Oct. 3, 2000 illustrates an autographed picture frame.

U.S. Pat. No. D456,447 issued to Ader et al on Apr. 30, 2002 illustrates a combined photo album and autograph book.

U.S. Pat. No. 6,736,429 issued to Steeg on May 18, 2004 discloses a combination writing surface and pen assembly that is used to facilitate obtaining autographs includes a sports object equivalent having a writing surface, in the shape of the object of a sport, capable of receiving writing or marking. A pen or other writing instrument has a writing end and a non-writing end, where a connector connects the pen to the sports object equivalent. There is preferably also a hole in the sports object equivalent for receiving the pen.

U.S. Published Patent Applications No. 2002/0174584, inventor White et al., published on Nov. 28, 2002, discloses an assembly for displaying an item of memorabilia in three-dimensions including: a rigid support substrate for mounting on a wall; a protective layer adapted to co-extensively abut a part of a surface of the rigid support, said protective layer including an opening therein; a memorabilia display housing, said housing including a shaped portion to receive a three-dimensional shaped item of memorabilia of similar size to the shaped portion, said shaped portion having at least a transparent or translucent viewing part; and in an assembled condition a part of the housing is held by the protective layer or the rigid support and an item of memorabilia is received within the shaped portion of the housing so as to enable display in a three-dimensional form.

U.S. Published Patent Applications No. 2004/0163299, inventor Werb, published on Aug. 26, 2004, discloses a method and apparatus for preparing pet memorabilia utilizes both the efforts of a pet owner and of a processing center remote from the residence of the pet owner. The method employs materials provided in a container. The materials enable a pet owner to take an impression of the paw of a dog or other pet. The container is sized to receive the impression. The container is designed to be mailed to the remote processing center. The remote processing center using the impression to prepare a casting. A special cellulose—silicate casting material is used to take a casting. After the casting is completed, it is mounted on a display and returned to the pet owner.

U.S. Published Patent Applications No. 2005/0160651, inventor Davis, published on Jul. 28, 2005, discloses a matting system for framing, archiving and displaying display items having a display board with window openings, a carrier board with window openings in line with and slightly larger than the window openings of the display board. The carrier board having hinged doors, which fit into the window openings and a backer board which holds the doors of the carrier board closed so as to maintain the display item between the door and a frame extension created between the dissimilar sized openings of the display board and the carrier board.

U.S. Published Patent Applications No. 2006/0207894, inventor Maglione, published on Sep. 21, 2006, discloses a trunk which houses an infant outfit and infant blanket appointed to clothe and swaddle a newborn infant on the momentous journey home from the hospital. Also included by the container are a plurality of cards adapted for documenting the joyous journey. The infant outfit, infant blanket, and cards are safely stored and displayed within the container. A memorabilia system and method are thereby provided for memorializing and commemorating the infant's first journey home from the hospital. The memorabilia system and method are operable to accommodate at least five generations of infant home journeys.

U.S. Published Patent Applications No. 2006/0248769, inventor Rose, published on Nov. 9, 2006, discloses a display device provides for the displaying of collectible cards on two side. The device includes a generally planar card support mat, a mat having a pair of opposed planar surfaces with apertures extending therethrough. The apertures are sized to support a collectible card therein. A pair of transparent plates overlie each of the planar surfaces of the mat allowing viewing of each side of the two-sided card. A frame bounds and supports the mat and encloses the cards in a tamper evident protective manner.

U.S. Published Patent Applications No. 2007/0051658, inventor Schroeder, published on Mar. 8, 2007, discloses an apparatus and method of use thereof, to assist in the signing and protection of sports memorabilia articles while on the field of play. Means for attaching or holding a writing implement is provided on the apparatus. The main body of the apparatus, preferably constructed from plastic, is contoured to facilitate griping the apparatus while a player is signing the article. In alternative embodiments, the apparatus may be constructed in a two-piece, interlocking design to permit multiple uses. The apparatus may also bear graphical information for advertising, identification, or other informational uses.

Additionally, high speed motorized engraving tools for precise metal-engraving are well known in the art.

While these patents, published patent applications, and other previous methods have attempted to solve the problems that they addressed, none have utilized or disclosed a guest signature memorabilia kit and system capable of facilitating non-fading signatures, as does embodiments of the technology disclosed herein.

Additionally none have utilized or disclosed a memorabilia kit and system where a plexi/glass covering goes behind a metal mat board. Typically in traditional framing the plexi/glass goes in front of a cardboard matte and picture. The technology disclosed herein has no need to protect a metal mat board with plexi/glass, only an actual photo/document that is framed needs to be protected. The metal mat board for this kit is durable, does not tarnish or fade based due to the material it is produced from.

Therefore, a need exists for a memorabilia kit and system with these attributes and functionalities. The memorabilia kit and system according to embodiments of the invention substantially departs from the conventional concepts and designs of the prior art. It can be appreciated that there exists a continuing need for a new and improved memorabilia kit and system which can be used commercially. In this regard, the technology disclosed herein substantially fulfills these objectives.

### BRIEF SUMMARY OF THE INVENTION

In general, the technology described herein features a memorabilia kit and system. In a typical embodiment, the elements of the kit include a memorabilia assembly, a signature engraving scribe, a polishing cloth and an instruction card.

The memorabilia assembly is typically comprised of a frame, a metal signature mat board, a first backing material, a protective material, a second backing material, flex-tabs and hanging hardware.

The frame may be made of wood, metal or plastic material.

The mat board is made of a material capable of being hand-engraved by the signature engraving scribe, e.g. anodized aluminum, a polished alloy.

The first backing material may be made of a suitable material for placement between the mat board and the protective material.

The protective material may be Plexiglas, glass, or any other material that allows a viewer to observe the memorabilia item.

The second backing material may be made of a material that is suitable for placement behind the memorabilia item and is that is capable of receiving the flex tabs and the hanging hardware. The second backing material may be configured to serve as a “door” when it is desired to remove or insert a memorabilia item from the rear of the memorabilia assembly.

The flex-tabs and hanging hardware are well known in the art.

The signature engraving scribe is an easy-to-use diamond-tipped engraving scribe with a specially designed tip that enables hand-signing a permanent signature or message into the material of the mat board with normal hand pressure, i.e., as if signing with an ink pen. The signature engraving scribe is has no moving parts and does not have any batteries. The tip of the scribe is a custom shaped diamond that engraves into the mat board when the user writes, using normal hand signing pressure.

The polishing cloth is made of a material suitable for removing smudges or finger prints from the mat board after guest signs the mat board or whenever needed.

The instruction card is preferably dimensioned to be 5″ by 7″ and contains instructions to the guests for signing the mat board using the signature engraving scribe. The instruction card is preferably placed by a user into a standard picture frame and displayed next to the memorabilia assembly.

Embodiments of the memorabilia assembly may include a memorabilia place-holder, e.g. a stock photo, a stock document, that is removed by a user and replaced with a user-provided memorabilia item.

Embodiments of the memorabilia kit may include a standard picture frame with the instruction card already inserted.

Embodiments of the memorabilia kit may include a stand for displaying the memorabilia assembly, a stand for displaying the standard picture frame, or both stands.

The user supplied memorabilia item may be a photo, artwork, a document, or any other item capable of being positioned between the protective material and the backing material.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The foregoing patent and other information reflect the state of the art of which the inventor is aware and are tendered with a view toward discharging the inventor's acknowledged duty of candor in disclosing information that may be pertinent to the patentability of the technology disclosed herein. It is respectfully stipulated, however, that the foregoing patent and other information do not teach or render obvious, singly or when considered in combination, the inventor's claimed invention.

It is therefore an aspect of the technology described herein to provide a new and improved memorabilia kit and system which has all the advantages of the prior art memorabilia and none of the disadvantages.

One advantage of the technology described herein is that it integrates a durable guest signature element into a memorabilia preservation assembly.

Another advantage of the technology described herein to provide a new and improved memorabilia kit and system which may be easily and efficiently manufactured and marketed.

A further advantage of the technology described herein to provide a new and improved memorabilia kit which is of durable and reliable construction.

These aspects and advantages, together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The technology described herein, together with further advantages thereof, may best be understood by reference to the following description of the simplest form of the technology described herein, taken in conjunction with the accompanying drawings in which:

FIG. 1 illustrates an exploded view of a memorabilia kit, according to an embodiment of the technology disclosed herein.

FIG. 2 illustrates an elevation view of a memorabilia kit, according to an embodiment of the technology disclosed herein.

FIG. 3 illustrates a door-type rear access for a memorabilia assembly, according to an embodiment of the technology disclosed herein.

FIG. 4 illustrates a rear elevation view of a memorabilia assembly, according to an embodiment of the technology disclosed herein.

FIG. 5 shows detail of flex-tabs, according to an embodiment of the technology disclosed herein.

FIG. 6 illustrates a non-door access of a memorabilia assembly, according to an embodiment of the technology disclosed herein.

FIG. 7 illustrates a signature engraving scribe, according to an embodiment of the technology disclosed herein.

### DETAILED DESCRIPTION OF THE INVENTION

The technology disclosed herein will now be described in detail with reference to at least one preferred embodiment thereof as illustrated in the accompanying drawings. In the following description, numerous specific details are set forth in order to provide a thorough understanding of the technology disclosed herein. It will be apparent, however, to one skilled in the art, that the technology disclosed herein may be practiced without some or all of these specific details. In other instances, well known operations have not been described in detail so not to unnecessarily obscure the technology disclosed herein.

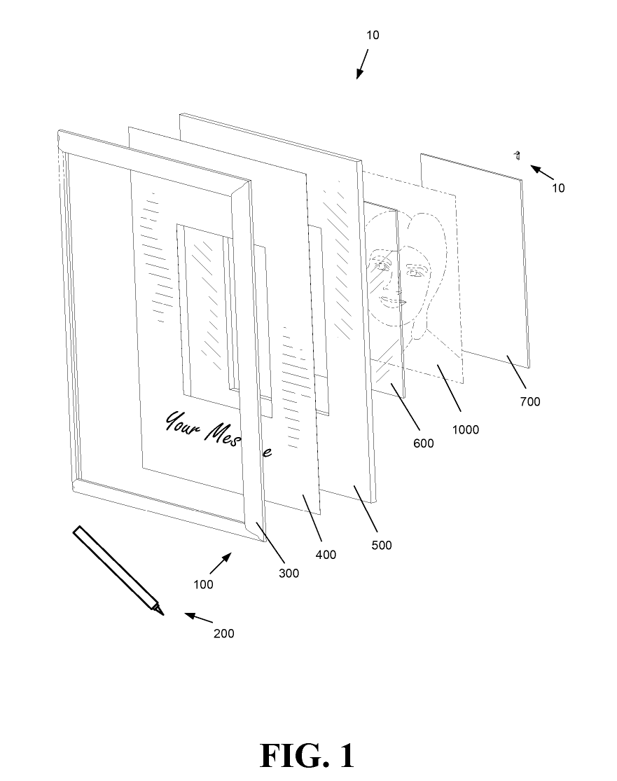

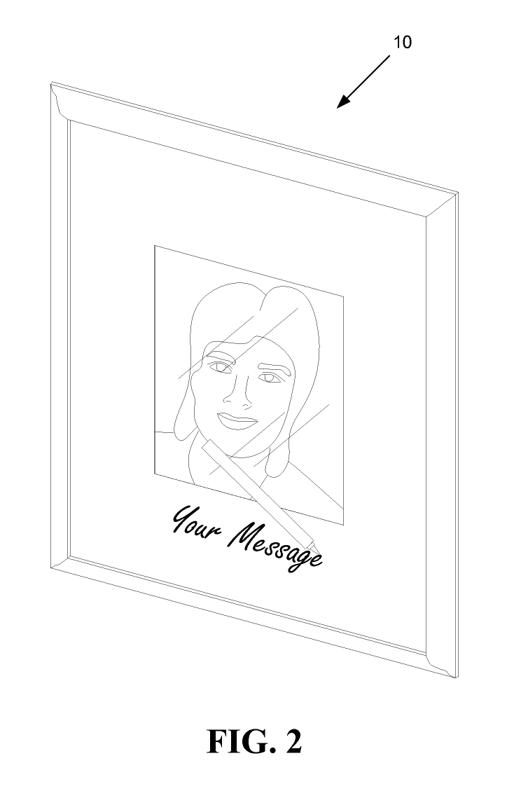

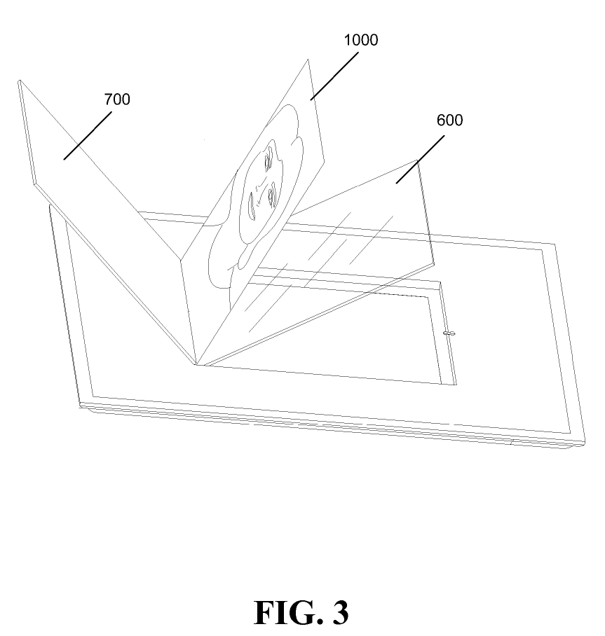

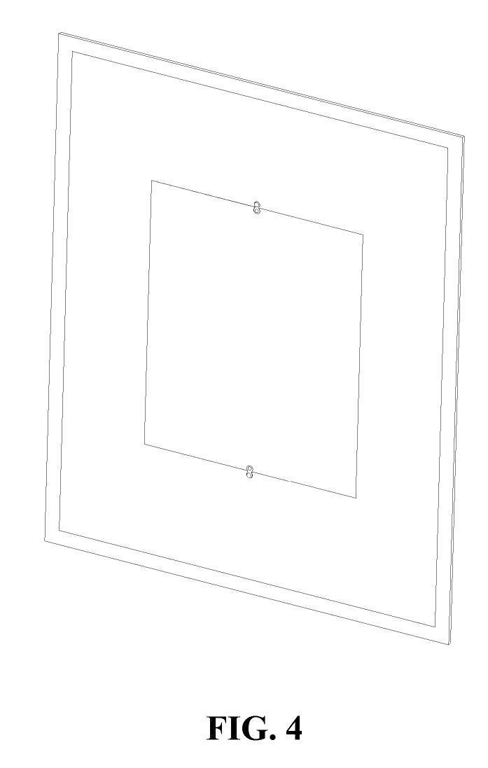

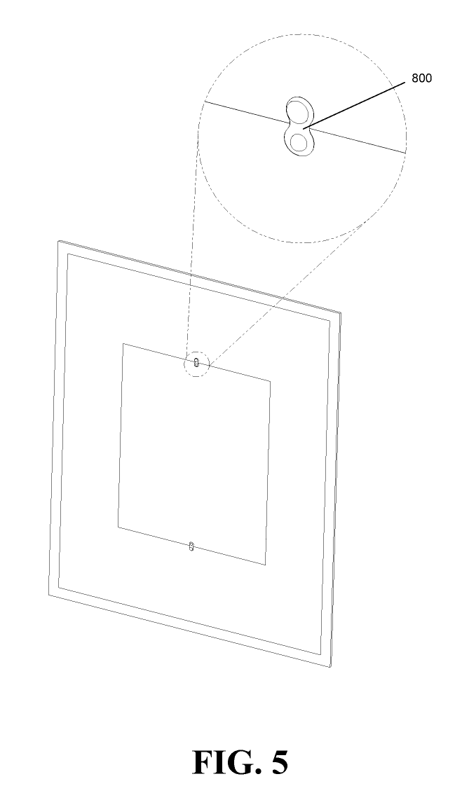

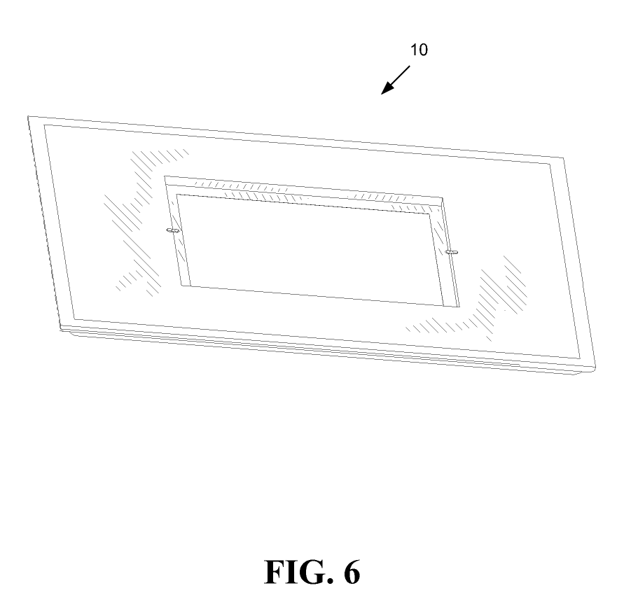

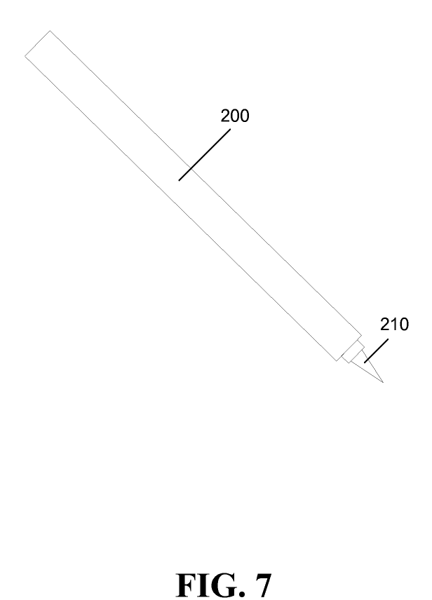

Referring to the drawings, FIGS. 1-9, wherein like reference numerals designate corresponding parts throughout the several figures, reference is made first to FIG. 1 that illustrates elements of an exemplary embodiment of a memorabilia kit 10.

In general, the memorabilia kit 10 comprises a memorabilia assembly 100 and a signature engraving scribe 200. The memorabilia kit 10 may be further comprised of a polishing cloth (not shown) and an instruction card (not shown).

The memorabilia assembly 100 is typically comprised of a frame 300, a metal signature mat board 400, a first backing material 500, a protective material 600, a second backing material 700, a plurality of a flex-tab 800 and a hanging hardware 900.

The frame 300 may be made of wood, metal or plastic material.

The metal signature mat board 400 is made of a material capable of being hand-engraved by the signature engraving scribe, e.g. aluminum, a special alloy.

The first backing material 500 may be made of a suitable material for placement between the metal signature mat board 400 and the protective material 600.

The protective material 600 may be Plexiglas, glass, or other material that allows a viewer to observe the memorabilia item.

The second backing material 700 may be made of a suitable material for placement behind the memorabilia item and is capable of receiving the hanging hardware 900 and the flex-tabs 800. The second backing material 700 may serve as a “door” when it is desired to remove or insert a memorabilia item.

The flex-tabs 800 and hanging hardware 900 are well known in the art.

The signature engraving scribe 200 is dimensioned to be an easy-to-use diamond-tipped or carbide-tipped engraving scribe especially designed for hand-signing a permanent signature or message into the material of the metal signature mat board 400 with normal hand pressure, i.e., as if signing with an ink pen. The signature engraving scribe 200 is not mechanical and does not have any batteries. The tip 210 of the signature engraving scribe 200 is a custom shaped diamond that engraves into the mat board when the user writes, using normal hand signing pressure.

The polishing cloth is made of a material suitable for removing smudges or finger prints from the metal signature mat board 400 after signing or whenever needed.

The instruction card is preferably dimensioned to be 5″ by 7″ and contains instructions for guests for signing the metal signature mat board 400 using the signature engraving scribe 200. The instruction card is preferably placed by a user into a standard picture frame and displayed next to the memorabilia assembly 100 and signature engraving scribe 200.

Embodiments of the memorabilia assembly 100 may include a memorabilia place-holder 1000, e.g. a stock photo, document, that is removed by a user and replaced with a user-provided memorabilia item.

Embodiments of the memorabilia kit 10 may include a standard picture frame with the instruction card already inserted.

Embodiments of the memorabilia kit 10 may include a stand for displaying the memorabilia assembly, a stand for displaying the standard picture frame, or both stands.

The user supplied memorabilia item 1000 may be a photo, artwork, a document, or any other item capable of being positioned between the protective material and the backing material.

The memorabilia assembly 100 may be dimensioned for any standard or non-standard frame size and with any size or shape opening, e.g. a 11″×14″, 16″×20″, 20″×24″.

An embodiment of the Memorabilia Kit 10 may be assembled as follows:
Acquire a frame
Place a Metal Signature Mat inside the frame
Place Frame backing in next (this piece may have an access door to place in the next two pieces . . . plexi/glass and cardboard matte)
Place Plexi/glass in the opening/door in the back of the frame backing
Place a cardboard matte next. This is used to mount the picture or artwork onto and provides additional decorative edging to the picture/artwork.
Place the picture or object to be framed in next
Secure with an acid free tape or simply laid in place (would be held in place by the backing)
Place a door or opening cover last
Secure in place

Optionally, instead of using a “door” system for the frame backing a solid frame backing could be used with a full size piece of plexi/glass and full size piece of cardboard matte. The “door” system is used as a means to reduce the size of the plexi/glass and cardboard matte that is used (since it is placed behind the metal mat board and only a small portion is actually visible).

With respect to the above description, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

The foregoing description and drawings comprise illustrative embodiments of the technology disclosed herein. Having thus described exemplary embodiments of the technology disclosed herein, it should be noted by those skilled in the art that the within disclosures are exemplary only, and that various other alternatives, adaptations and modifications may be made within the scope of the technology disclosed herein. Merely listing or numbering the steps of a method in a certain order does not constitute any limitation on the order of the steps of that method. Many modifications and other embodiments of the technology described herein will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the technology disclosed herein is not limited to the specific embodiments illustrated herein, but is limited only by the following claims.

What is claimed is:

1. A picture frame assembly and associated engraving system, the system comprising:
an engravable signature mat board located within a picture frame assembly and having a display area opening for an item to be framed, the engravable signature mat board configured to be engraved upon; and
an engraving pen having a tip configured for use by a user to engrave a message upon the engravable signature mat board.

2. The picture frame assembly and associated engraving system of claim 1, further comprising:
a picture frame having four frame elements which are joined at adjacent corners to form a rectangular shape, the picture frame configured to receive the engravable signature mat board inserted within;
a frame backing located behind the engravable signature mat board, the frame backing having a rectangular rear opening and a flap to cover the rectangular rear opening;
a piece of glass material to be placed into the rectangular rear opening of the frame backing; and
a cardboard matte to mount the item to be framed within the picture frame behind the piece of glass material, the cardboard matte configured to provide decorative edging to the item to be framed, the cardboard matte and the item to be framed located within the rectangular rear opening.

3. The picture frame assembly and associated engraving system of claim 2, further comprising:
a plurality of flex tabs located on a back side of the frame backing to sustain the flap when the flap is in a closed position and covering the rectangular rear opening.

4. The picture frame assembly and associated engraving system of claim 1, wherein the engravable signature mat board comprises a metal.

5. The picture frame assembly and associated engraving system of claim 1, wherein the engravable signature mat board comprises pewter.

6. The picture frame assembly and associated engraving system of claim 1, wherein the engravable signature mat board comprises an anodized aluminum alloy.

7. The picture frame assembly and associated engraving system of claim 1, wherein the tip of the engraving pen comprises a diamond.

8. The picture frame assembly and associated engraving system of claim 1, wherein the tip of the engraving pen comprises carbide.

9. A method for manufacturing a picture frame assembly with an engravable signature mat board, the method comprising:
placing an engravable signature mat board within a picture frame assembly, the engravable signature mat board having a display area opening for an item to be framed; and
utilizing an engraving pen having a tip, configuring the engraving pen for use by a user to engrave a message upon the engravable signature mat board.

10. The method for manufacturing a picture frame assembly with an engravable signature mat board of claim 9, further comprising:
utilizing a picture frame having four frame elements which are joined at adjacent corners to form a rectangular shape, configuring the picture frame to receive the engravable signature mat board inserted within;
utilizing a frame backing and placing the frame backing behind the engravable signature mat board, the frame backing having a rectangular rear opening and a flap to cover the rectangular rear opening;
utilizing a piece of glass material, placing the piece of glass material into the rectangular rear opening of the frame backing; and
utilizing a cardboard matte to mount the item to be framed within the picture frame behind the piece of glass material, the cardboard matte configured to provide decorative edging to the item to be framed, the cardboard matte and the item to be framed located within the rectangular rear opening.

11. The method for manufacturing a picture frame assembly with an engravable signature mat board of claim 10, further comprising:
mounting a plurality of flex tabs on a back side of the frame backing to sustain the flap when the flap is in a closed position and covering the rectangular rear opening.

12. The method for manufacturing a picture frame assembly with an engravable signature mat board of claim 9, wherein the engravable signature mat board comprises a metal.

13. The method for manufacturing a picture frame assembly with an engravable signature mat board of claim 9, wherein the engravable signature mat board comprises pewter.

14. The method for manufacturing a picture frame assembly with an engravable signature mat board of claim 9, wherein the engravable signature mat board comprises an anodized aluminum.

15. The method for manufacturing a picture frame assembly with an engravable signature mat board of claim 9, wherein the tip of the engraving pen comprises a diamond.

16. The method for manufacturing a picture frame assembly with an engravable signature mat board of claim 9, wherein the tip of the engraving pen comprises carbide.

17. An engravable metal mat board for use in a picture frame assembly, the engravable metal mat board comprising:
a thin, engravable metal mat board to be placed in a picture frame assembly; and
a display area opening located on the thin, engravable metal mat board to allow for the display of an item to be framed with the picture frame assembly.

18. The engravable metal mat board for use in a picture frame assembly of claim 16, wherein the thin metal engravable surface is an anodized aluminum.

19. A metal engraving pen for use on an engravable metal mat board in a picture frame assembly, the metal engraving pen comprising:
a stylus; and
an engraving tip configured to permanently inscribe a message on an engravable metal mat board in a picture frame assembly.

20. The metal engraving pen for use on an engravable metal mat board in a picture frame assembly of claim 19, wherein the engraving tip comprises carbide.

21. The metal engraving pen for use on an engravable metal mat board in a picture frame assembly of claim 19, wherein the engraving tip comprises a diamond.
